(19) United States
(12) Patent Application Publication
(10) Pub. No.: US 2025/0261243 A1
(43) Pub. Date: Aug. 14, 2025

(54) METHOD FOR PERFORMING AN RANDOM ACCESS PROCEDURE BY A USER EQUIPMENT

(71) Applicant: Continental Automotive Technologies GmbH, Hannover (DE)

(72) Inventors: Rikin Shah, Langen (DE); David Gonzalez Gonzalez, Egelsbach (DE); Hojin Kim, Regensburg (DE); Reuben George Stephen, Singapore (SG)

(73) Assignee: Continental Automotive Technologies GmbH, Hannover (DE)

(21) Appl. No.: 18/880,561

(22) PCT Filed: Jun. 28, 2023
(86) PCT No.: PCT/EP2023/067750

§ 371 Date: Jan. 1, 2025

(30) Foreign Application Priority Data
Jul. 1, 2022 (DE) 10 2022 206 750.9

(51) Int. Cl. H04W 74/0833; H04W 72/231

(52) U.S. Cl. CPC H04W 74/0833; H04W 72/231

(57) ABSTRACT

An RA (Random Access) procedure is performed by a UE (User Equipment) in cell of a gNB (next-generation Node B) of a mobile network. The UE activates, based on first data, a primary PCell. The UE receives second data from the gNB about one or more secondary PCells for (i) configuring the one or more secondary PCells and for (ii) performing an RA procedure in the one or more secondary PCells. The UE further receives third data from the gNB, indicating which of the one or more secondary PCells is to be activated. After the UE determines that the primary PCell is switched off, it activated the indicated secondary PCell, based on the second and third data. The UE performs an RA procedure in the activated secondary PCell based on the second data.

### CROSS-REFERENCE TO RELATED APPLICATIONS

The present application is a National Stage Application under 35 U.S.C. § 371 of International Patent Application No. PCT/EP2023/067750 filed on Jun. 28, 2023, and claims priority from German Patent Application No. 10 2022 206 750.9 filed on Jul. 1, 2022, the disclosures of which are herein incorporated by reference in their entireties.

### TECHNICAL FIELD

The invention relates to a method for performing or enabling an RA (Random Access) procedure by a UE (User Equipment) in cell of a gNB (next-generation Node B) of a mobile network.

### BACKGROUND

In a mobile network, a UE, for example a mobile phone, may be configured with one Primary cell or PCell and up to 15 auxiliary cells called Secondary Cells or SCells. These cells are provided by a single base station, which may be referred to as a next-generation Node B in the 3GPP standard.

The PCell provides basis control of the UE such as RRC connection management, radio bearer management, mobility management, and so on. The SCells serve as additional radio resource to the UE, the addition or removal of which depends on the amount of traffic.

The purposes of an RA (Random Access) procedure by the UE are requesting uplink radio resource and aligning uplink transmission timing. Since the same transmission buffer and same transmission timing of the gNB are used for all cells, there is no need to perform an RA procedure in an SCell and, indeed, in the current version of the relevant 3GPP standards, such RA procedure is not allowed in a SCell.

In order to improve network energy savings in terms of base station transmission and reception energy consumption, cells may be temporarily switched off, when the expected traffic volume is lower than a fixed threshold. A switch-off period of a cell may be less than a second or in the order of millisecond.

A network may thus switch off a PCell of a UE. The UE may not be allowed to initiate an RA procedure in its SCells and will thus delay its RACH (Random Access Channel) procedure until the PCell is switched on again. This would increase the latency and/or delay in the data transmission. This increased latency and/or delay is not desirable for high priority data transmission.

The objective of the invention is to reduce the delay and or latency when a PCell of a UE is switched off.

### BRIEF SUMMARY

The objective of the invention is met by providing a method, a UE, and a network node according to the independent claims.

According to a first aspect, a method for performing an RA (Random Access) procedure by a UE (User Equipment) in cell of a gNB (next-generation Node B) of a mobile network is provided, preferably executed in said UE, wherein the method comprises the steps of
receiving first data from a gNB about a primary PCell (Primary cell) for configuring said primary PCell;
based on said first data, activating said primary PCell;
using said activated primary PCell, receiving second data from said gNB about one or more secondary PCells for (i) configuring said one or more secondary PCells and for (ii) performing an RA procedure in said one or more secondary PCells;
receiving third data from said gNB, indicating which of said one or more secondary PCells is to be activated;
determining that said primary PCell is switched off;
based on said second data and said third data, activating said indicated secondary PCell; and,
based on said second data, performing an RA procedure in said activated secondary PCell, and optionally a RACH (Random Access Channel) procedure in said activated secondary PCell.

According to the invention, the UE may be provided with information (i.e. the second and third data) for quickly switching over to a new PCell (i.e. said secondary PCell) when the old PCell (i.e. said primary PCell) has been switched off. In the new PCell, the UE is allowed to perform an RA procedure and, optionally a RACH procedure. This will reduce any delay and or latency in the data transmission.

An alternative procedure for a UE to activate a new PCell is a so-called hand-over procedure when the UE is handed over from one gNB to another gNB. Such hand-over procedure requires a lot of data or information (at least more than according to the invention) to be exchanged between at least the UE and the new gNB. This could add to the delay and latency and increase the overall power consumption.

A User Equipment may be vehicle that is arranged for connecting to a communication network, a mobile telephone or any other device that is arranged for connecting to a communication network, preferably a wireless network. Examples of such a communication network are cellular mobile networks, for example as defined by 3GPP, for example by the current frozen Release 16 of 3GPP.

In one or more embodiments, the first data and/or second data may be received as an RRC information or an RRC message (RRC=Radio Resource Control). In one or more embodiments, the second data may be transmitted and received once, for example together with the first data.

In other embodiments the second data may be transmitted and received periodically. In yet other embodiments, the transmission of the second data is triggered by a change in the set of one or more available secondary PCells as determined by the gNB or by network. The second data may comprise information about an index number identifying each of the one or more available secondary PCells.

In one or more embodiments, the third data may be received as an MAC CE (Media Access Control Control Element) information. In a further embodiment, the third data is comprised in a MAC header. In one or more embodiments, the third data may be transmitted and received periodically.

In yet other embodiments, the transmission of the third data is triggered when the network (or the gNB) determines that a new cell (i.e. different than the cell that was identified in the previously transmitted third data) is to become the secondary PCell after the primary PCell is switched off. In yet other embodiments, the transmission of the third data is triggered when the network (or the gNB) determines that the primary PCell is about to be switched off.

In one or more embodiments, determining which of said one or more secondary PCells is to be activated, is based on comparison of traffic volumes of said one or more secondary PCells and/or comparison of signal strength of said one or more secondary PCells.

It may be expected that third data is transmitted much more often than the second data. Since the third data may only have to comprise an index number, its transmittal and processing may require little processing time (and/or processing energy), which may further reduce delay and/or latency.

In one or more embodiments, the third data may be received and transmitted periodically. Indeed, in order to save network energy, cells may be periodically switched off. In that case, switching over to a new PCell may also be done periodically.

In one or more embodiments, the third data may comprise a scheme indicating at what time which of multiple secondary PCells is to be activated. To reduce the network energy consumption, cells may be switched off according to energy saving plan, indicated when which cell is to be switched off in an upcoming time period. When this plan is known, the third data can be sent/received only once in order to indicate which secondary PCells is to be activated at what time during said upcoming time period.

The UE may determine that said primary PCell is switched off based on information it receives from the gNB or based on a Loss-of-Signal of the primary PCell.

In one or more embodiments, the method further comprises the steps of:
using said activated primary PCell, receiving fourth data from said gNB about one or more SCells assigned to said secondary PCell for configuring said one or more SCells;
based on said fourth data, activating one or more SCells assigned to said primary PCell;

In one or more embodiments, the method further comprises the steps of
using said activated secondary PCell, receiving fifth data from said gNB about one or more SCells assigned to said secondary PCell for configuring said one or more SCells;
based on said fifth data, activating one or more SCells assigned to said secondary PCell.

As described above, the UE may use the SCells as additional radio resource, next to the PCell.

In one or more embodiments, the method further comprises the steps of
receiving information about a switch-off period of said primary PCell;
determining that said primary PCell is switched off based on said received information; and, optionally,
after determining that said switch-off period has ended, re-activating said primary PCell and de-activating said secondary PCell and, optionally, re-activating said SCells assigned to said primary PCell and de-activating said SCells assigned to said secondary PCell.

The switch-off period of a PCell may be relatively short, for example less than 1 second, or even a few milliseconds. In that case, it may be advantageous for a UE to shortly use another PCell (the secondary PCell) when its current PCell (the primary PCell) is switched off.

In one or more embodiments, the UE may calculate the start and/or the end of the switch-off period based on the information about the switch-off period and time information from an internal clock.

In one or more embodiments, the information about the switch-off period comprises information about a switch-off time, at which the switch-off period starts. In one or more embodiments, the information about the switch-off period is comprised in the third data.

According to a second aspect, a method for enabling a UE performing an RA procedure in cell of a gNB (next-generation Node B) of a mobile network is provided, preferably to be executed in a gNB, wherein the method comprises the steps of:
transmitting first data to a UE about a primary PCell for configuring said primary PCell;
transmitting second data to said UE about one or more secondary PCells for (i) configuring said one or more secondary PCells and for (ii) performing an RA procedure in said one or more secondary PCells;
determining that said primary PCell is to be switched off;
determining which of said one or more secondary PCells is to be activated by said UE when said primary PCell is switched off;
transmitting third data to said UE indicating said determined secondary PCell;
switching off said primary PCell.

In one or more embodiments, the method further comprises the steps of:
determining that said primary PCell is to be switched off during a switch-off period, which starts at a switch-off time;
transmitting information about said switch-off period and/or said switch-off time to said UE; and, optionally,
after said switch-off period has ended, switching on said primary PCell.

In one or more embodiments, the method further comprises the steps of:
establishing an energy saving plan, indicating at what time which PCell is to be switched off in an upcoming time period;
determining a scheme indicating at what time which of said multiple secondary PCells is to be activated in the upcoming time period, based on said energy saving plan;
wherein said third data comprises said scheme.

In one or more embodiments, the method further comprises the steps of:
using an activated primary PCell, transmitting fourth data to said UE about one or more SCells assigned to said primary PCell for configuring said one or more SCells; and/or,
using an activated secondary PCell, transmitting fifth data to said UE about one or more SCells assigned to said secondary PCell for configuring said one or more SCells.

In one or more embodiments, the method further comprises the steps of:
selecting said one or more secondary PCells from said one or more SCells assigned to said primary PCell, preferably based on a pre-determined traffic volume threshold.

In one or more embodiments, said determining which of said one or more secondary PCells is to be activated, is based on comparison of traffic volumes of said one or more secondary PCells and/or comparison of signal strengths of said one or more secondary PCells.

In one or more embodiments, said second data about one or more secondary PCells comprises for each of said PCells information about: an index number identifying said secondary PCell, information about a BWP (Bandwidth Path) and/or information about an RACH Resources Configuration.

In one or more embodiments,
said first data, said fourth data and said fifth data are comprised in RRC (Radio Resource Control) information; and/or,
said second data are comprised in RRC information or MAC CE (Media Access Control Control Element) information; and/or,
said third data are comprised in MAC CE information or RRC information.

In one or more embodiments, said first data and/or said second data and/or said fourth data are transmitted together as a single RRC message by said gNB to said UE.

According to a third aspect, a UE (User Equipment) is provided, which is arranged for performing an RA procedure in cell of a gNB of a mobile network; comprising:
one or more transceivers for communicating with said gNB using one or more PCells and/or SCells of said gNB;
a processor for carrying out steps of a computer program;
a computer-readable medium having stored thereon a computer program, comprising instructions which, when the program is executed by said processing unit, cause the UE to carry out the steps of the method of various claims.

According to a fourth aspect, a Mobile Network Node, preferably a gNB, is provided, which is arranged for enabling a UE performing an RA procedure in cell of said Node, comprising:
one or more transceivers for communicating with said UE using one or more PCells and/or SCells of said node;
a processor for carrying out steps of a computer program;
a computer-readable medium having stored thereon a computer program, comprising instructions which, when the program is executed by said processing unit, cause the node to carry out the steps of the method of various claims.

According to a sixth aspect, a computer-readable medium is provided, having stored thereon a computer program, comprising instructions which, when the program is executed by a computer, cause the computer to carry out the steps of any embodiments of a method as described in this document.

The working, advantages and embodiments of the UE, the Mobile Network Node, the method for enabling a UE performing an RA procedure in cell of a gNB, as well as the working, advantages and embodiments of the computer-readable medium, correspond with the working, advantages and embodiments of the method for performing an RA (Random Access) procedure by a UE (User Equipment) in cell of a gNB as described in this document, with the necessary changes having been made.

### BRIEF DESCRIPTION OF THE DRAWINGS

For a more complete understanding of the present invention, reference in the following description is made to the accompanying drawings.

FIG. 1 shows a schematic overview of a use case involving a UE, a gNB and three cells of this gNB.

FIG. 2 shows a schematic overview of a UE according to one or more embodiments of the invention.

FIG. 3 shows a schematic overview of a network node (a gNB) according to one or more embodiments of the invention.

FIG. 4 shows a schematic overview of a method for performing an RA procedure according to one or more embodiments of the invention to be executed in a UE.

FIG. 5 shows a schematic overview of a method for enabling a UE performing an RA procedure according to one or more embodiments of the invention to be executed in a gNB.

### DETAILED DESCRIPTION

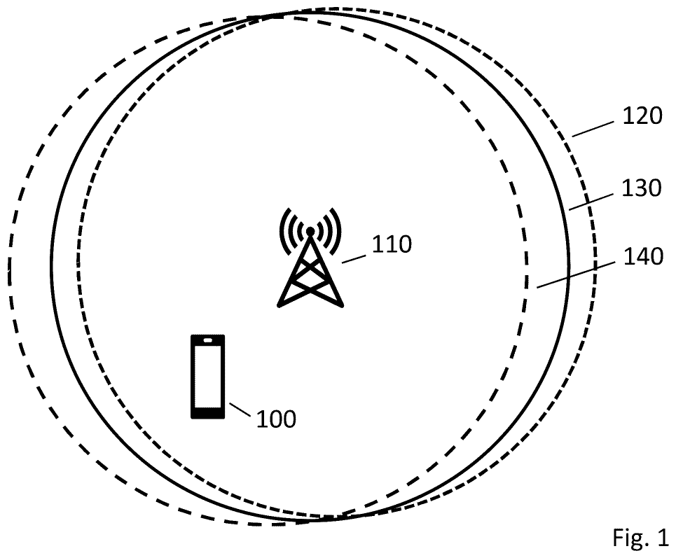

FIG. 1 shows schematic overview of an exemplary use case involving a UE 100, a gNB 110 and three cells 120, 130 and 140 of this gNB. Cell 120 may be a primary PCell for UE 100. Cells 130 and 140 may be a SCell and/or a secondary PCell. In general, a PCell for a first UE may also serve as a SCell for a second UE.

In one or more embodiments, the UE 100 may be a vehicle, such as a car, a motorbike, a van, a truck, a bicycle or a scooter.

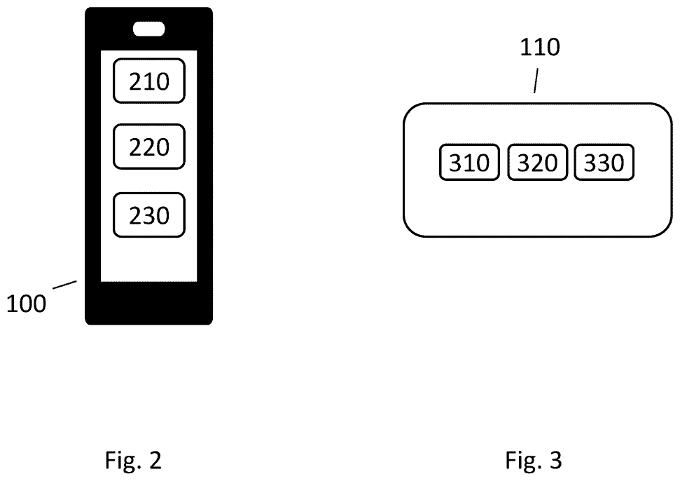

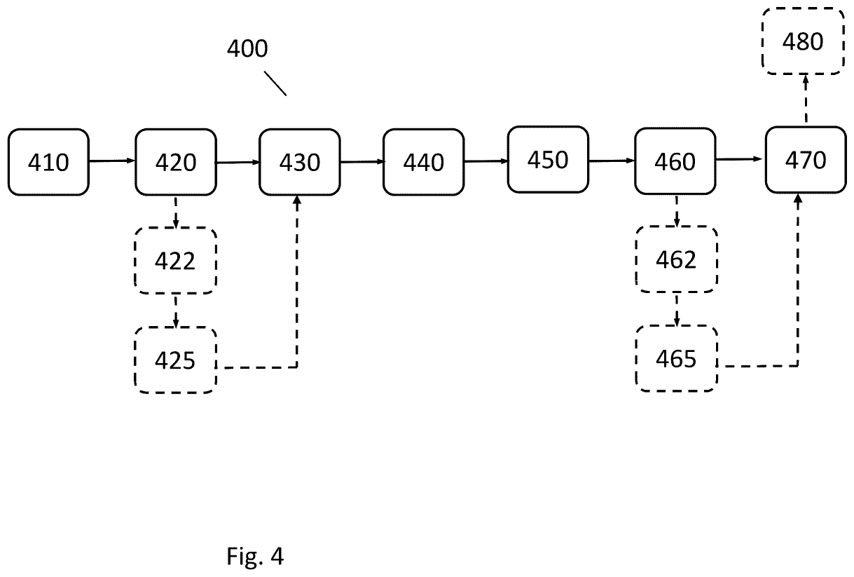

FIG. 2 shows a schematic overview of a UE 100 according to one or more embodiments of the invention which is arranged for performing an RA (Random Access) procedure in cell of gNB 110. The UE 100 comprises at least one or more transceivers 210 for communicating with said gNB using one or more PCells and/or SCells of gNB 110. It further comprises a processing unit 220 for carrying out steps of a computer program, that is stored on a computer-readable medium 230. The computer program comprises instructions which, when the program is executed by said processing unit 220, cause UE 100 to carry out the steps of the method 400 as described below with reference to FIG. 4.

FIG. 3 shows a schematic overview of a network node or gNB 110, which is arranged for enabling UE 100 performing an RA procedure in cell of gNB 110. In this document, the network node is a gNB, but it may also be a different kind of node, such as a 3G or 4G base station.

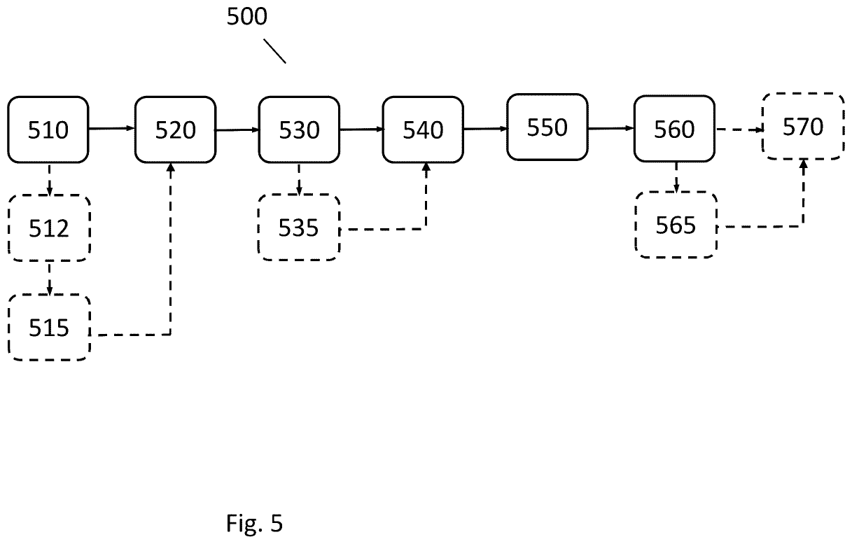

The gNB 110 comprises one or more transceivers 310 for communicating with UE 100 using one or more PCells and/or SCells of said node. It further comprises a processor unit 320 for carrying out steps of a computer program, that is stored on a computer-readable medium 330. The computer program comprises instructions which, when the program is executed said processing unit 320, cause the gNB 110 to carry out the steps of the method 500 as described below with reference to FIG. 5.

With reference to FIG. 1 and FIG. 4, the following steps of method 400-preferably to be executed by UE 100-will be described:

Step 410: receiving first data from gNB 110 about a primary PCell 120 for configuring said primary PCell 120.

In one or more embodiment, the first data comprises information about a BWP (Bandwidth Path) and/or information about a RACH Resources Configuration and/or PUCCH (Physical Uplink Control Channel) resource configuration). In general, a UE may be arranged for transmitting information about a RACH and/or PUCCH resources when available.

Step 420: based on said first data, activating primary PCell 120.

In one or more embodiment, the method 400 may further comprise step 422: using said activated primary PCell 120, receiving fourth data from said gNB about one or more SCells 130, 140 assigned to said primary PCell 120 for configuring said one or more SCells; and step 425: based on said fourth data, activating one or more SCells 130, 140 assigned to said primary PCell 120. The activated SCells may serve as additional radio resources to UE 100.

Step 430: using activated primary PCell 120, receiving second data from gNB 110 about one or more secondary PCells 130, 140 for (i) configuring said one or more secondary PCells 130, 140 and for (ii) performing an RA procedure in said one or more secondary PCells 130, 140 and, optionally, for (iii) performing a RACH (Random Access Channel) procedure in said activated secondary PCell.

In one or more embodiment, the second data comprises information about a BWP (Bandwidth Path) and/or information about an RACH Resources Configuration for each of the one or more secondary PCells 130, 140 and an index number identifying said secondary PCell. The second data may further comprise information about PUCCH (Physical Uplink Control Channel) resource configuration. In one or more embodiment, the first and/or the second data are received by UE 100 (and thus transmitted by gNB 110) as RRC (Radio Resource Control) information.

An example of the RRC information which may comprise the second data is presented in the table below:

| | BWP | Sec PCell | RACH Resources | Sec |
|---|---|---|---|---|
| | info | Index | Configuration | PCell |
| UE | BWP1 | 1 | RA1 | SP1 (130) |
| | BWP2 | 2 | RA2 | SP2 (140) |
| | BWP3 | 3 | RA3 | SP3 |
| | BWP 4 | 4 | RA4 | SP4 |

In FIG. 1, only secondary PCells 130 and 140 are indicated, but gNB 110 could transmit second data about more secondary PCells, for example secondary PCells SP3 and SP4. For each secondary PCell in table 1, an index number n has been provided. Furthermore, for each secondary PCells, respective BWP information BWPn and RACH Resources Configuration RAn is provided.

Step 440: receiving third data from gNB 110, indicating which of said one or more secondary PCells 130, 140 is to be activated. The third data may be transmitted and received periodically or according to a pre-determined time interval.

In one or more embodiments the third data comprises the index number of the secondary PCell that is to be activated. Since the UE 100 may already have retrieved all the relevant information for activating the selected PCell from the second data, the third data needs only to comprise the index number.

In one or more embodiments, the third data is comprised in a MAC CE header of information that is received by the UE 100 and transmitted by gNB 110. For example, when the gNB has determined that secondary PCell 130 is to be activated by UE 100 when primary PCell 120 is switched off, the MAC CE may indicate 00000001 to the UE 100.

An example of the MAC CE information which may comprise the third data is presented below as an octet:

| SP8 | SP7 | SP6 | SP5 | SP4 | SP3 | SP2 | SP1 |
|---|---|---|---|---|---|---|---|
| 0 | 0 | 0 | 0 | 0 | 0 | 0 | 1 |

In one or more embodiments, the third data may comprise a scheme indicating at what time which of multiple secondary PCells is to be activated in an upcoming period. In that case, the third data may comprise multiple instances of MAC CE information as indicated above, with for each instance information indicating at what time the secondary PCell as indicated in the MAC CE information is to be activated.

Step 450: determining that said primary PCell 120 is switched off;

In one or more embodiments, the gNB 110 transmits information about a switch-off period of primary PCell 120 to UE 100. The UE 100 may then determine that primary PCell 120 is switched off based on the received information. In one or more embodiments, RRC signaling may be used for transmitting this information. In this case the transmitting may be semi-statically. In one or more other embodiments, DCI (Downlink Control Information) signaling may be used for transmitting this information. In that case the transmitting may be dynamically.

The information about a switch-off period may be based on an energy saving plan, indicating at what time which PCell is to be switched off in an upcoming time period.

In another embodiment, UE 100 may determine that primary PCell 120 is switched off based on a Lost-of-Signal of primary PCell 120.

Step 460: based on said second data and said third data, activating said indicated secondary PCell 130;

In one or more embodiment, the method 400 may further comprise step 462: using said activated secondary PCell 130, receiving fifth data from said gNB about one or more SCells 140 assigned to said secondary PCell 130 for configuring said one or more SCells 140; and step 465: based on said fifth data, activating one or more SCells 140 assigned to said secondary PCell 130. Also in this case, the activated SCells may serve as additional radio resources to UE 100.

Step 470: based on said second data, performing an RA procedure in said activated secondary PCell 130.

Since UE 100 has activated a new PCell 130, it can perform an RA procedure in this PCell, whenever this is required, with reduced delay and latency.

In one or more embodiments, the method 400 may further comprise step 480: after determining that said switch-off period has ended, re-activating said primary PCell 120 and de-activating said secondary PCell 130 and, optionally, re-activating said SCells 130, 140 assigned to said primary PCell 120 and de-activating said one or more SCells 140 assigned to said secondary PCell 130.

In one or more embodiments, the UE 100 may determine that primary PCell 120 is switched on again based on the received information about said switch-off period of primary PCell 120.

With reference to FIG. 1 and FIG. 5, the following steps of method 500 for enabling a UE performing an RA procedure in cell of a gNB (next-generation Node B) of a mobile network, the method 500 to be executed by gNB 110, will be described. The steps of method 400 are mirrored by the steps of method 500.

Step 510: transmitting first data to a UE about a primary PCell for configuring said primary PCell;

In one or more embodiments, method 500 may further comprise step 512: using an activated primary PCell 120, transmitting fourth data to said UE 100 about one or more SCells 130, 140 assigned to primary PCell 120 for configuring said one or more SCells 130, 140.

In one or more embodiments, method 500 may further comprise step 515: selecting one or more secondary PCells 130, 140 from said one or more SCells 130, 140 assigned to said primary PCell, preferably based on a pre-determined traffic volume threshold. SCells that may have a traffic volume below a pre-determined volume may be said to have sufficient capacity for taking over the role of primary PCell for UE 100.

Step 520: transmitting second data to said UE about one or more secondary PCells for (i) configuring said one or more secondary PCells and for (ii) performing an RA procedure in said one or more secondary PCells.

It may be understood that the one or more secondary PCells 130, 140 for which second data is transmitted, are possible or alternative new PCells for the UE 100 when the old PCell 120 is switched off.

In one or more embodiments, the second data may be transmitted to the UE periodically. In one or more embodiments, the second data may be transmitted to the UE together with the first data.

Step 530: determining that said primary PCell is to be switched off;

The gNB 110 may determine that the primary PCell 120 needs be switched off, for example to reduce the power consumption of gNB 110, which may be on the basis of information provided by other entities in the network.

In one or more embodiments, method 500 may further comprise the step 535: determining that said primary PCell is to be switched off during a switch-off period, which starts at a switch-off time; and transmitting information about said switch-off period and/or said switch-off time to said UE.

In one or more embodiments, step 530 comprises establishing an energy saving plan, indicating at what time which PCell is to be switched off in an upcoming time period. The energy saving plan may be determined by the gNB or by another entity in the communication network to which the gNB is a part of.

In one or more embodiment, transmitting the second data to the UE may be triggered by the determination that the primary PCell is to be switched off. In that case, step 530 will precede step 520.

Step 540: determining which of said one or more secondary PCells 130, 140 is to be activated by said UE 100 when said primary PCell 120 is switched off;

In one or more embodiments, step 540 may comprise determining a scheme indicating at what time which of said multiple secondary PCells is to be activated in the upcoming time period, based on said energy saving plan

In one or more embodiments, the gNB 110 determines which of said one or more secondary PCells is to be activated, is based on comparison of traffic volumes of said one or more secondary PCells and/or on comparison of signal strengths of said one or more secondary PCells. For example, the PCell with the smallest traffic volume may be seen as having the largest capacity for taking over the role as new PCell for UE 100 and may thus be determined as the secondary PCell that UE 100 should activate when its signal strength is above a predefined threshold.

Step 550: transmitting third data to said UE indicating said determined secondary PCell.

In one or more embodiments, said third data comprises said scheme indicating at what time which of said multiple secondary PCells is to be activated in the upcoming time period.

In one or more embodiment, step 540 and/or step 550 are triggered by step 530. In other embodiments, step 540 and/or step 550 are executed periodically.

Step 560: switching off said primary PCell.

In one or more embodiments, the primary PCell 120 is switched off at the above-mentioned switch-off time and for a period equal to said switch-off period.

In one or more embodiments, method 500 further comprises step 565: using an activated secondary PCell 130, transmitting fifth data to said UE 100 about one or more SCells 140 assigned to said secondary PCell for configuring said one or more SCells 140.

In one or more embodiments, method 500 further comprises step 570: switching on said primary PCell. In one or more embodiments, primary PCell 120 is switched on again after the above-mentioned switch-off time has ended.

The format and content of the first, second, third, fourth and fifth data in embodiments of method 500 is identical to the format and content of the first, second, third, fourth and fifth data in embodiments of method 400 respectively.

In general, the first data, fourth data and fifth data may be comprised in RRC (Radio Resource Control) information and/or transmitted together as sixth data. The second data may be comprised in RCC information or MAC CE (Media Access Control Control Element) information. The third data may be comprised in MAC CE information or RCC information. In general, the second and third data may be transmitted together as seventh data.

The first data and/or the second data and/or the fourth data may be transmitted together as a single RRC message by said gNB 110 to said UE 100.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for performing an RA (Random Access) procedure by a UE (User Equipment) in cell of a gNB (next-generation Node B) of a mobile network, the method comprising
receiving first data from a gNB about a primary PCell (Primary cell) for configuring said primary PCell;
based on said first data, activating said primary PCell;
using said activated primary PCell, receiving second data from said gNB about one or more secondary PCells for (i) configuring said one or more secondary PCells and for (ii) performing an RA procedure in said one or more secondary PCells;
receiving third data from said gNB, indicating which of said one or more secondary PCells is to be activated;
determining that said primary PCell is switched off;
based on said second data and said third data, activating said indicated secondary PCell; and,
based on said second data, performing an RA procedure in said activated secondary PCell, and, optionally, a RACH (Random Access Channel) procedure in said activated secondary PCell.

2. Method The method according to claim 1, further comprising:
using said activated primary PCell, receiving fourth data from said gNB about one or more SCells assigned to said secondary PCell for configuring said one or more SCells;
based on said fourth data, activating one or more SCells assigned to said primary PCell; and/or,
using said activated secondary PCell, receiving fifth data from said gNB about one or more SCells assigned to said secondary PCell for configuring said one or more SCells;
based on said fifth data, activating one or more SCells assigned to said secondary PCell.

3. Method according to claim 1, further comprising:
receiving information about a switch-off period of said primary PCell;
determining that said primary PCell is switched off based on said received information; and, optionally,
after determining that said switch-off period has ended, re-activating said primary PCell and de-activating said secondary PCell and, optionally, re-activating said SCells assigned to said primary PCell and de-activating said SCells assigned to said secondary PCell.

4. A method for enabling a UE performing an RA procedure in cell of a gNB (next-generation Node B) of a mobile network, comprising
transmitting first data to a UE about a primary PCell for configuring said primary PCell;
transmitting second data to said UE about one or more secondary PCells for (i) configuring said one or more secondary PCells and for (ii) performing an RA procedure in said one or more secondary PCells;
determining that said primary PCell is to be switched off;
determining which of said one or more secondary PCells is to be activated by said UE when said primary PCell is switched off;
transmitting third data to said UE indicating said determined secondary PCell;
switching off said primary PCell.

5. The method according to claim 4, further comprising:
determining that said primary PCell is to be switched off during a switch-off period, which starts at a switch-off time;
transmitting information about said switch-off period and/or said switch-off time to said UE; and, optionally,
after said switch-off period has ended, switching on said primary PCell. and/or
establishing an energy saving plan, indicating at what time which PCell is to be switched off in an upcoming time period;
determining a scheme indicating at what time which of said multiple secondary PCells is to be activated in the upcoming time period, based on said energy saving plan;
wherein said third data comprises said scheme.

6. The method according to claim 4, further comprising:
using an activated primary PCell, transmitting fourth data to said UE about one or more SCells assigned to said primary PCell for configuring said one or more SCells; and/or,
using an activated secondary PCell, transmitting fifth data to said UE about one or more SCells assigned to said secondary PCell for configuring said one or more SCells.

7. The method according to claim 6, further comprising:
selecting said one or more secondary PCells from said one or more SCell assigned to said primary PCell, preferably based on a pre-determined traffic volume threshold.

8. The method according to any of claim 4, wherein said determining which of said one or more secondary PCells is to be activated, is based on comparison of traffic volumes of said one or more secondary PCells and/or comparison of signal strengths of said one or more secondary PCells.

9. The method according to claim 1, wherein said second data about one or more secondary PCells comprises for each of said PCells information about: an index number identifying said secondary PCell, information about a BWP (Bandwidth Path) and/or information about an RACH Resources Configuration.

10. The method according to claim 1, wherein
said first data, said fourth data and said fifth data are comprised in RRC (Radio Resource Control) information; and/or,
said second data are comprised in RCC information or MAC CE (Media Access Control Control Element) information; and/or,
said third data are comprised in MAC CE information or RCC information.

11. The method according to claim 1, wherein said first data and/or said second data and/or said fourth data are transmitted together as a single RRC message by said gNB to said UE.

12. A UE (User Equipment) arranged for performing an RA procedure in cell of a gNB of a mobile network; comprising:
one or more transceivers for communicating with said gNB using one or more PCells and/or SCells of said gNB;
a processor for carrying out steps of a computer program;
a non-transitory computer-readable medium having stored thereon computer-executable instructions which, when executed by said processing unit, cause the UE to perform operations comprising:
receiving first data from a gNB about a primary PCell (Primary cell) for configuring said primary PCell:
based on said first data, activating said primary PCell;
using said activated primary PCell, receiving second data from said gNB about one or more secondary PCells for (i) configuring said one or more secondary PCells and for (ii) performing an RA procedure in said one or more secondary PCells;
receiving third data from said gNB, indicating which of said one or more secondary PCells is to be activated;
determining that said primary PCell is switched off;
based on said second data and said third data, activating said indicated secondary PCell; and,
based on said second data, performing an RA procedure in said activated secondary PCell, and, optionally, a RACH (Random Access Channel) procedure in said activated secondary PCell.

13. AgNB Mobile Network Node arranged for enabling a UE performing an RA procedure in cell of said Node, comprising:
one or more transceivers for communicating with said UE using one or more PCells and/or SCells of said node;
a processor for carrying out steps of a computer program;
a non-transitory computer-readable medium having stored thereon computer-executable instructions which, when executed by said processing unit, cause the network node to perform operations comprising:
transmitting first data to a UE about a primary PCell for configuring said primary PCell;
transmitting second data to said UE about one or more secondary PCells for (i) configuring said one or more secondary PCells and for (ii) performing an RA procedure in said one or more secondary PCells;
determining that said primary PCell is to be switched off;
determining which of said one or more secondary PCells is to be activated by said UE when said primary PCell is switched off;
transmitting third data to said UE indicating said determined secondary PCell;
switching off said primary PCell.

14. (canceled)
